(19) United States
(12) Patent Application Publication
(10) Pub. No.: US 2026/0323147 A1
(43) Pub. Date: Oct. 15, 2026

(54) Camera Module and Manufacturing Method Therefor

(71) Applicant: NINGBO SUNNY OPOTECH CO.,LTD, Yuyao City (CN)

(72) Inventors: Hiroshi OSADA, Yuyao City (CN); Pengfei ZHOU, Yuyao City (CN)

(21) Appl. No.: 19/691,412

(22) Filed: May 28, 2026

Related U.S. Application Data
(63) Continuation of application No. PCT/CN2024/132973, filed on Nov. 19, 2024.

(30) Foreign Application Priority Data
Nov. 29, 2023 (CN) 2023116180624
Nov. 19, 2024 (WO) PCT/CN2024/132973

(51) Int. Cl. H04N 23/54; G03B 17/17; H01F 5/00; H01F 5/04; H04N 23/55

(52) U.S. Cl. CPC H04N 23/54; G03B 17/17; H01F 5/003; H01F 5/04; H04N 23/55; G03B 2205/0023; G03B 2205/0069

(57) ABSTRACT

A camera module includes an optical module, a movable member, a coil assembly, and a magnet, wherein the magnet includes a first portion and a second portion respectively forming polarity portions with different polarities on a side facing the coil assembly, the coil assembly includes a substrate and a coil pattern formed on the substrate, the coil pattern includes a first coil pattern extending along a first direction and a second coil pattern extending along a second direction perpendicular to the first direction, an extending direction of the first coil pattern is parallel to an arrangement direction of the first portion and the second portion, and a width of the first coil pattern is greater than a width of the second coil pattern.

### CROSS REFERENCE OF RELATED APPLICATION

This is a Continuation Application of PCT/CN2024/132973, filed Nov. 19, 2024, which claims priority under 35 U.S.C. 119(a-d) to Chinese application number CN202311618062.4, filed Nov. 29, 2023, the afore-mentioned patent applications are hereby incorporated by reference in their entireties.

### BACKGROUND OF THE PRESENT INVENTION

### Field of Invention

The present invention relates to the field of camera modules, and more particularly to a camera module and a method for manufacturing the same.

### Description of Related Arts

The camera module is an essential component of mobile electronic devices. With the further development of camera module technology, users' demands for camera modules have become increasingly refined and higher. The development of camera products not only needs to meet high-performance requirements but also needs to satisfy miniaturization and lightweight requirements.

The camera module comprises a lens module, a motor, and a photosensitive module. Light passes through the lens module to reach the photosensitive module and is received by the photosensitive chip of the photosensitive module. The motor is used to drive the lens module or the photosensitive module and other optical modules.

In order to further improve imaging quality and realize more imaging functions, camera modules usually feature auto-focus (AF) and optical image stabilization (OIS) functions. The motor drives the optical module to achieve these functions. Most motors are voice coil motors. A voice coil motor generates driving force through the interaction of a magnet and a coil. The performance of the coil and magnet affects the overall performance of the motor. For example, the line width, thickness, and number of windings of the coil affect its performance. When powered, the coil generates heat. The resistance of the coil affects the amount of heat produced, which in turn affects the power consumption of the motor. Therefore, it is necessary to design the coil properly to ensure its performance while minimizing resistance to reduce motor power consumption.

Currently, the coil design of voice coil motors used in camera modules mainly adopts uniform-width wiring, where the line width is the same at any position. The coil traces typically have uniform width, thickness, and spacing, which simplifies the coil design but cannot provide optimal performance.

The resistance of the coil is inversely proportional to its cross-sectional area. Therefore, increasing the cross-sectional area of the coil is a potential approach to reduce resistance. For example, the cross-sectional area of the coil can be increased by spirally varying the line width. However, this method greatly increases the coil size. At present, the miniaturization requirements for camera modules are becoming increasingly strict, and the space occupied within electronic devices is very limited. End manufacturers have stringent size requirements for camera modules. Therefore, excessively increasing the coil size makes it difficult for the overall camera module to meet miniaturization design requirements.

### SUMMARY OF THE PRESENT INVENTION

One advantage of this application is that it provides a camera module and a method for manufacturing the same, wherein the resistance of the coil assembly and the power consumption of the actuator are reduced by increasing the local area of the coil assembly of the actuator, thereby improving the quality of the camera module.

One advantage of this application is that it provides a camera module and a method for manufacturing the same, wherein the local linewidth in each coil pattern unit is increased to increase the cross-sectional area of the coil assembly, thereby reducing the resistance value of the coil assembly and reducing the heat generation of the coil assembly.

One advantage of this application is that it provides a camera module and a method for manufacturing the same, wherein by only increasing the local linewidth in each coil pattern unit, avoiding an excessively large overall size of the coil assembly and meeting the design requirements for miniaturization of the camera module are achieved.

One advantage of this application is that it provides a camera module and a method for manufacturing the same, wherein coil patterns are printed on a substrate and can form coil pattern shapes with different local line widths according to preset coil patterns, thereby effectively reducing the resistance of the coil assembly and improving the performance of the coil assembly.

One advantage of this application is that it provides a camera module and a method for manufacturing the same, wherein the coil assembly is mounted onto the printed circuit board, thereby integrating the coil assembly onto the printed circuit board.

One advantage of this application is that it provides a camera module and a method for manufacturing the same, wherein the quality is enhanced by increasing the linewidth of the coil pattern in the portion of the coil pattern unit that does not affect the driving force of the actuator, thereby avoiding any impact on the driving performance of the actuator.

According to one aspect of this application, this application provides a camera module, comprising:
an optical module, a movable member, a coil assembly, and a magnet, wherein the optical module is mounted on the movable member, one of the coil assembly and the magnet is mounted on the movable member and is arranged at at least one side of the optical module, wherein the coil assembly and the magnet are arranged to interact to generate a driving force that drives the movable member to carry the optical module to move;
wherein the magnet comprises a first portion and a second portion, wherein the first portion and the second portion respectively form poles with different polarities on a side facing the coil assembly;
wherein the coil assembly comprises a substrate and a coil pattern formed on the substrate, wherein the coil pattern comprises a first coil pattern extending along a first direction and a second coil pattern extending along a second direction perpendicular to the first direction;
wherein an extending direction of the first coil pattern is parallel to an arrangement direction of the first portion and the second portion, and a width of the first coil pattern is greater than a width of the second coil pattern.

According to an embodiment of this application, the first coil pattern is protruded at least partially with respect to the magnet along the second direction.

According to an embodiment of this application, the first coil pattern is oriented toward the first portion and the second portion.

According to an embodiment of this application, the coil pattern comprises a plurality of coil pattern units each comprising a first coil pattern unit extending along the first direction and a second coil pattern unit extending along the second direction, wherein a width of the first coil pattern unit is greater than a width of the second coil pattern unit.

According to an embodiment of this application, the first coil pattern unit comprises a plurality of coil units connected in parallel.

According to an embodiment of this application, a distance between each two coil pattern units is the same, and a distance between each two adjacent first coil pattern units is the same, and a distance between each two adjacent second coil pattern units is the same.

According to an embodiment of this application, the first coil pattern and the second coil pattern are at the same distance from corresponding edges of the substrate.

According to an embodiment of this application, a printed circuit board is further provided, wherein the coil assembly is soldered on the printed circuit board, wherein the substrate is provided with at least one soldering area for fixed connection with the printed circuit board.

According to an embodiment of this application, a fixed member is further provided, wherein the movable member is movably mounted to the fixed member, and the other of the coil assembly and the magnet is mounted to the fixed member.

According to an embodiment of this application, the optical module is a light path deflection module, wherein the coil assembly and the magnet are mounted on two sides of the light path deflection module, the extending direction of the first coil pattern is parallel to a light emitting direction of the light path deflection module, and an extending direction of the second coil pattern is parallel to a light incident direction of the light path deflection module, wherein the magnet and the coil assembly are arranged to interact to generate the driving force parallel to the light emitting direction to drive the light path deflection module to rotate around a first rotation axis which is parallel to the light incident direction.

According to an embodiment of this application, the movable member comprises a first movable component, a second movable component, and a guide component, wherein the first movable component and the second movable component are movably mounted on the fixed member along the second direction, the guide component is mounted between the first movable component and the second movable component to guide a movement of the first movable component, wherein the camera module further comprises a second coil assembly and a second magnet, the second coil assembly and the second magnet are respectively mounted on the fixed member and the first movable component along the first direction to drive the first movable component to rotate around a second rotation axis.

According to an embodiment of this application, the second movable component is mounted on a bottom of the first movable component along the second direction, wherein the second movable component comprises two support arms extending along the second direction and opposite to each other along the third direction, wherein the two support arms are extended to two opposite sides of the first movable component along the third direction, wherein each of the two support arms has a second receiving groove at a top thereof, wherein each guide component is fitted into the corresponding second receiving groove, wherein a center position of the guide component is located at the second rotation axis.

According to an embodiment of this application, a gap is defined between the first portion and the second portion, each of the two support arms is located in the gap, and portions of the first portion and the second portion facing the coil assembly form poles with opposite polarities.

According to an embodiment of this application, a side of the first movable component is provided with a first movable assembly space and a second movable assembly space, the first portion and the second portion are respectively assembled in the first movable assembly space and the second movable assembly space, a receiving portion is provided between the first movable assembly space and the second movable assembly space, and the receiving portion is provided with a first sub-receiving groove and a second sub-receiving groove along the second direction, at least a part of the guide component is received into the first sub-receiving groove, and one of the two support arms is extended into the second sub-receiving groove.

According to an embodiment of this application, the optical module is a lens module, and the coil assembly and the magnet are disposed on at least one side of the lens module and arranged to interact to generate the driving force parallel to an optical axis of the lens module, wherein the extension direction of the first coil pattern is parallel to the optical axis of the lens module.

According to another aspect of this application, the application provides a method for manufacturing a camera module, comprising the following steps:
providing a substrate with a coil pattern comprising a first coil pattern extending along a first direction and a second coil pattern extending along a second direction perpendicular to the first direction, wherein a width of the first coil pattern is greater than a width of the second coil pattern;
soldering a coil assembly formed by the coil pattern and the substrate on a printed circuit board; and
mounting one of the coil assembly and a magnet to a movable component, and mounting the other of the coil assembly and the magnet to a fixed member, wherein the magnet comprises a first portion and a second portion, wherein the first portion and the second portion respectively form polarity portions with different polarities on one side facing the coil assembly, and the first portion and the second portion are arranged along the first direction.

### BRIEF DESCRIPTION OF THE DRAWINGS

FIG. 1A is a simplified schematic view of the coil assembly of some examples of the camera module according to this application.

FIG. 1B is a schematic view of the interaction between the coil assembly and the magnet of some examples of the camera module according to this application.

FIG. 1C is a cross-sectional schematic view of the coil assembly of some examples of the camera module according to this application.

FIG. 2A is a schematic view of one embodiment of the coil assembly of some examples of the camera module according to this application.

FIG. 2B is a schematic view of another embodiment of the coil assembly of some examples of the camera module according to this application.

FIG. 3A is a schematic view of an example of the actuator according to this application being applied to a periscope camera module for driving a light path deflection module.

FIG. 3B is a schematic view of an example structure of the actuator according to this application applied to the periscope camera module for driving the light path deflection module.

FIG. 4A is a partial exploded view of the example of the actuator according to this application being applied to the periscope camera module for driving the light path deflection module.

FIG. 4B is a schematic view of the interaction between the coil assembly and the magnet of the example of the actuator according to this application being applied to the periscope camera module for driving the light path deflection module.

FIG. 5A is a simplified schematic view of an example of an actuator according to this application being applied to a periscope camera module for driving a lens module.

FIG. 5B is a simplified schematic view of the coil assembly and magnet of the example of the actuator according to this application applied to the periscope camera module for driving the lens module.

FIG. 5C is a schematic view of the interaction between the coil assembly and the magnet of the example of the actuator according to this application applied to the periscope camera module for driving the lens module.

FIGS. 6A and 6B are simplified schematic views of the coil assembly mounted on the printed circuit board of some examples of the camera module according to this application.

FIG. 7 is a simplified schematic view of the coil assembly of some examples of the camera module according to this application.

### DETAILED DESCRIPTION OF THE PREFERRED EMBODIMENT

The following description is intended to disclose the present invention and enable those skilled in the art to implement it. The preferred embodiments described below are merely examples, and other obvious variations will occur to those skilled in the art. The basic principles of the invention defined in the following description can be applied to other embodiments, modifications, improvements, equivalents, and other technical solutions that do not depart from the spirit and scope of the invention.

Those skilled in the art should understand that, in the disclosure of this invention, the terms “longitudinal”, “lateral”, “upper”, “front”, “back”, “left”, “right”, “perpendicular”, “horizontal”, “top”, “bottom”, “inner”, “outer”, and etc., indicate the orientation or positional relationship based on the orientation or positional relationship shown in the accompanying drawings. They are only for the convenience of describing this invention and simplifying the description, and do not indicate or imply that the device or element referred to must have a specific orientation, or be constructed and operated in a specific orientation. Therefore, the above terms should not be construed as limiting this invention.

It is understood that the term “a” or “an” should be understood as “at least one” or “one or more”, that is, in one embodiment, the number of an element can be one, while in another embodiment, the number of the element can be multiple, and the term “a” or “an” should not be understood as a limitation on the number.

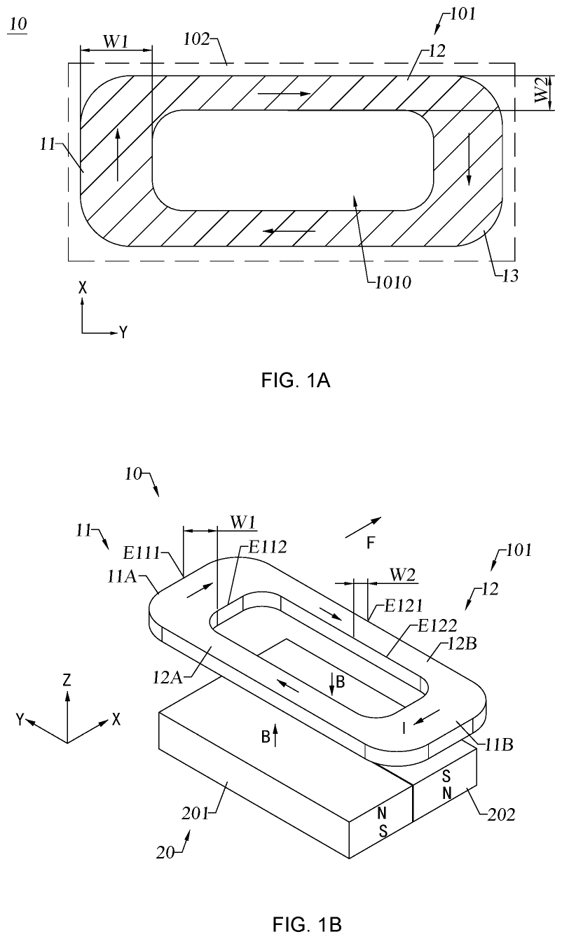

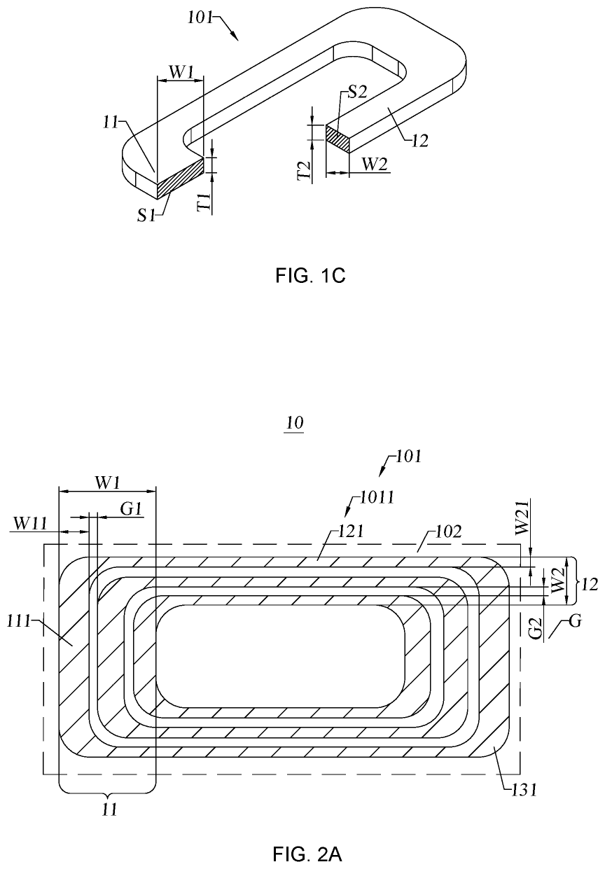

This application provides an actuator and a camera module using the actuator. The width of a local coil pattern in the coil assembly of the actuator is increased to reduce the resistance of the coil assembly, reduce the functionality of the actuator, and improve performance. Specifically, the design of increasing the width of the coil pattern in a localized area of each turn of the coil assembly avoids an excessively large overall size of the coil assembly, meeting the miniaturization design requirements of the camera module and improving its quality. The implementation methods and advantages of the camera module of this application are illustrated in conjunction with the drawings of FIGS. 1A to 7 of the specification.

Referring to FIGS. 1A to 1C, the actuator comprises a coil assembly 10 and a magnet 20. The magnet 20 and the coil assembly 10 are opposite to each other. When a current is passed through the coil assembly 10, it interacts with the magnetic field of the magnet 20 to generate a driving force F. The magnet 20 and the coil assembly 10 can generate a driving force in a direction perpendicular to the direction in which they face each other.

As shown in FIG. 1A, the coil assembly 10 comprises a coil pattern 101 and a substrate 102.

In one embodiment, the coil pattern 101 with electrical conductive property is formed on the insulating base layer of the substrate 102 according to a preset pattern.

The coil pattern 101 comprises a first coil pattern 11 extending along a first direction (X-axis) and a second coil pattern 12 extending along a second direction (Y-axis), the first direction and the second direction are orthogonal.

The current supplied to the coil assembly 10 moves along the coil pattern 101, passing through the first coil pattern 11 along the X-axis direction and passing through the second coil pattern 12 along the Y-axis direction.

As shown in FIG. 1B, the magnet 20 and coil assembly 10 are opposite to each other along a third direction (Z-axis). The magnetic field direction B of the magnet 20 is perpendicular to the current direction I of the coil pattern 101, that is, the magnetic field direction B of the magnet 20 is perpendicular to the velocity direction of moving charges in the coil pattern 101. Furthermore, the velocity direction of moving charges in the second coil pattern 12 is perpendicular to the magnetic field direction B of the magnet 20. The second coil pattern 12 and magnet 20 interact to generate the driving force F which is perpendicular to the third direction. The driving force F is perpendicular to the plane defined by the velocity direction of moving charges in the second coil pattern 12 and the magnetic field direction B of the magnet 20.

In other words, the second coil pattern 12 is the part of the coil assembly 10 that interacts with the magnetic field of the magnet 20 to generate the driving force F. The second coil pattern 12 and the magnet 20 are arranged opposite to each other to interact.

The resistance value of the coil assembly 10 affects its quality, the lower the resistance value, the higher the quality and the lower the loss in the coil assembly circuit. The resistance value of coil assembly 10 is inversely proportional to the cross-sectional area of the coil pattern 101. To reduce the resistance value, the cross-sectional area of the coil pattern 101 could be increased, such as by increasing its width or thickness. However, the internal space of the camera module is limited, and increasing the overall width and thickness of the coil pattern 101 might increase the overall size, affecting other structures. Therefore, referring to FIG. 1C, increasing the local cross-sectional area of the coil pattern 101 is considered to avoid making the overall size of the coil assembly 10 too large. Furthermore, if the cross-sectional area of the interaction between the coil pattern 101 and the magnet is increased, the impact on the movement of the actuator after increasing the area needs to be considered. Therefore, increasing the cross-sectional area of the first coil pattern 11 of the coil pattern 101 is considered. The cross-sectional direction is perpendicular to the plane defined by the first and second directions.

The second coil pattern 12 is opposite to the magnet 20, facing the N-pole and S-pole of the magnet 20. The current direction I of the second coil pattern 12 is perpendicular to the magnetic field direction B of the magnet 20, and they interact to generate the vertical driving force F. The current direction I of the first coil pattern 11 is parallel to the direction of the driving force F. Increasing the cross-sectional area of the first coil pattern 11 has a relatively small impact on the driving performance of the actuator.

As shown in FIG. 1B, the width W1 of the first coil pattern 11 is greater than the width W2 of the second coil pattern 12. The width W1 is the distance along the second direction between the outer edge E111 and the inner edge E112 of the first coil pattern 11 extending along the first direction; the width W2 is the distance along the first direction between the outer edge E121 and the inner edge E122 of the second coil pattern 12 extending along the second direction.

When forming the coil pattern 101 on the substrate 102, the width of the first coil pattern 11 is increased to reduce the resistance of the coil assembly 10. Alternatively, the width of the first coil pattern 11 is pre-set to be greater than the width of the second coil pattern 12, thus pre-setting the formation of the coil pattern 101. As shown in FIG. 1C, the cross-sectional area S1 of the first coil pattern 11 is affected by the width W1 and the thickness T1, while the cross-sectional area S2 of the second coil pattern 12 is determined by the width W2 and the thickness T2. When the width W1 is larger than the width W2 and the thickness T1 is equal to the thickness T2, the cross-sectional area S1 is larger than the cross-sectional area S2. Increasing the width W1 of the first coil pattern 11 increases the cross-sectional area S1 at that location, thereby reducing the resistance.

The first coil pattern 11 and the second coil pattern 12 are formed with the same thickness to facilitate printing on the substrate 102. The first coil pattern 11 and the second coil pattern 12 each can be a single layer or a multi-layer structure in the third direction (Z-axis) perpendicular to the first and second directions. Furthermore, increasing the thickness of the coil pattern 101 increases the cross-sectional area and reduces the resistance value.

Referring to FIG. 1B, the coil pattern 101 comprises two first coil patterns 11A and 11B extending in the first direction and opposite to each other in the second direction, and two second coil patterns 12A and 12B extending in the second direction and opposite to each other in the first direction.

The magnet 20 comprises a first portion 201 and a second portion 202 distributed along the first direction. The first portion 201 and the second portion 202 face the second coil patterns 12A and 12B arranged opposite to each other along the first direction, and form polarity portions with different polarities facing the second coil patterns 12A and 12B respectively.

The magnetic fields of the first portion 201 and the second portion 202 are in opposite directions and extend along the third direction. The currents of the second coil patterns 12A and 12B are in opposite directions and extend along the second direction perpendicular to the magnetic field directions of the first portion 201 and the second portion 202. The second coil pattern 12A interacts with the first portion 201, and the second coil pattern 12B interacts with the second portion 202 to generate the driving force F with force components in the same direction as the first direction. Changing the current direction can change the direction of the driving force F.

The extension direction of the first coil pattern 11 is parallel to the arrangement direction of the first portion 201 and the second portion 202. The second coil pattern 12 is oriented towards a single polarity portion, and the first coil pattern 11 is oriented towards two polarity portions of the magnet 20 with different polarities.

The first and second portions 201 and 202 facing the coil assembly 10 are respectively formed with N-polarity and S-polarity. The first portion 201 and the second portion 202 are implemented as two magnets with opposite magnetization directions, so as to interact with the second coil patterns 12A and 12B with opposite current directions of the coil assembly 10 respectively to generate the driving force F with force components in the same direction.

The first portion 201 and the second portion 202 are implemented as two parts with opposite magnetization directions, and can be connected to each other or distributed with intervals between them. Further, the first portion 201 and the second portion 202 are distributed with a certain space between them, or the first portion 201 and the second portion 202 are distributed as spacer components. The size of the magnet 20 is determined as a whole by the first portion 201, the second portion 202, and the interval between the first portion 201 and the second portion 202 along the first direction.

The projection of the magnet 20 along the third direction has a portion protruding along the first direction with respect to the projection of the coil pattern 101 along the third direction. The projection of the coil pattern 101 along the third direction has a portion protruding along the second direction with respect to the projection of magnet 20 along the third direction.

The projection of the second coil pattern 12 along the third direction and the projection of the magnet 20 along the third direction largely overlap. Furthermore, in some examples, the projection of the second coil pattern 12 along the third direction falls within the projection of the magnet 20 along the third direction. That is, the distance that the second coil pattern 12 extends along the second direction matches the distance that the magnet 20 extends along the second direction. Even further, the distance the second coil pattern 12 extending along the second direction does not exceed the distance the magnet 20 extending along the second direction. This allows the second coil pattern 12 to fully participate in the interaction with the magnet 20.

The projections of the second coil pattern 12A and the second coil pattern 12B along the third direction fall into the projections of the first portion 201 and the second portion 202 along the third direction respectively.

The projection of the first coil pattern 11 along the third direction protrudes along the second direction with respect to the projection of the magnet 20 along the third direction. That is, the first coil pattern 11 protrudes partially relative to the magnet 20 along the second direction. This makes the design of the first coil pattern 11 have a smaller impact on the driving performance of the actuator.

In one embodiment, the first coil pattern 11 faces the two polarity portions of the magnet 20 along the third direction, that is, the first coil pattern 11 faces the N polarity portion and the S polarity portion of the magnet 20. In this manner, the projections of the first coil pattern 11 and the magnet 20 along the third direction partially overlap with overlapping portions at the N polarity portion and the S polarity portion of the magnet 20 respectively.

In one embodiment, the first coil pattern 11 protrudes completely relative to the magnet 20 along the second direction, that is, the projections of the first coil pattern 11 and the magnet 20 along the third direction do not overlap.

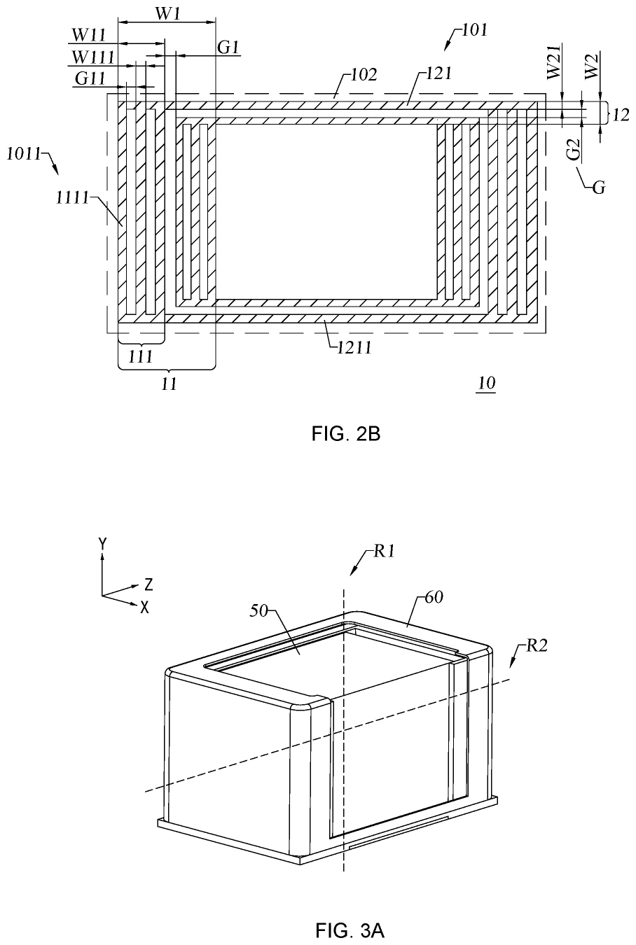

Referring to the schematic views in FIGS. 2A and 2B, the coil pattern 101 comprises a plurality of coil pattern units 1011 each forming a complete circle, that is, the coil pattern unit 1011 extends around the Z-axis in a complete circle. Each coil pattern unit 1011 comprises first coil pattern units 111 extending along the first direction and second coil pattern units 121 extending along the second direction. The first coil pattern units 111 and the second coil pattern units 121 are connected end to end and arranged in a complete circle.

Furthermore, the coil pattern 101 comprises a bending portion 13 which connects the first coil pattern 11 and the second coil pattern 12. Even further, each coil pattern unit 1011 comprises corresponding bending portion units 131 to connect the first coil pattern units 111 and the second coil pattern units 121.

In this embodiment, the coil pattern units 1011 are electrically connected. In one embodiment, after one coil pattern unit 1011 is formed, it extends inward or outward from the bending portion 13 at a certain angle, and continues to wrap around to form another coil pattern unit 1011. The remaining coil pattern units 1011 are formed sequentially in this manner, meaning the coil pattern 101 is formed in a spiral shape on the substrate 102. In one embodiment, each coil pattern unit 1011 has an electrical conductive connection portion.

The widths W11 of the plurality of the first coil pattern units 111 and the gaps G1 between each group of two adjacent first coil pattern units 111 form the total width W1 of the first coil pattern 11.

The widths W21 of the plurality of the second coil pattern units 121 and the gaps G2 between each group of two adjacent second coil pattern units 121 form the total width W2 of the second coil pattern 12.

In the example shown in FIG. 2A, the width W11 of the first coil pattern unit 111 of each coil pattern unit 1011 is greater than the width W21 of the second coil pattern unit 121, so as to reduce the resistance value of each coil pattern unit 1011, thereby reducing the resistance of the coil pattern 101.

In other words, the width of each circle of the coil pattern unit 1011 that does not participate in interaction with the magnetic field to generate the driving force F is increased, so as to increase the cross-sectional area of the coil pattern 101, reduce the resistance value, and avoid affecting the driving force of the actuator.

Furthermore, the gap G between each two coil pattern units 1011 is the same. Each coil pattern unit 1011 is distributed with a uniform gap interval to form the coil pattern 101. The gap G1 between each two adjacent first coil pattern units 111 is the same, and the gap G2 between each two adjacent second coil pattern units 121 is the same, and G is equal to G1 and is equal to G2. The coil pattern 101 has a uniform gap, which simplifies the design and reduces the molding difficulty on the substrate 102.

In the example shown in FIG. 2B, the first coil pattern unit 111 of each coil pattern unit 1011 comprises a plurality of first coil units 1111 connected in parallel, and the second coil pattern unit 121 comprises a second coil unit 1211. The width W11 of the first coil pattern unit 111 formed by the plurality of first coil units 1111 connected in parallel is greater than the width W21 of the second coil pattern unit 121 of the same coil pattern unit 1011.

That is, parallel coil units are added to the portion of each coil pattern unit 1011 that does not participate in the interaction with the magnetic field to generate the driving force F, forming a parallel circuit to reduce the resistance value. This makes the width W1 of the first coil pattern 11 formed by adding the first coil units 1111 connected in parallel larger than the width W2 of the second coil pattern 12.

Furthermore, the width of the second coil unit 1211 is the same as the width W21 of the second coil pattern unit 121. The width W111 of the first coil unit 1111 and the width W21 of the second coil unit 1211 are the same. The gap G11 between each two first coil units 1111 is the same as the gap G1 between each two first coil pattern units, and the same as the gap G2 between each two second coil pattern units 121. That is, the coil pattern 101 has uniform gaps to simplify the design. Based on this, local parallel circuits are added to effectively reduce resistance.

Alternatively, the second coil pattern unit 121 may comprise a plurality of second coil units 1211, the number of which is less than the number of first coil units 1111 connected in parallel. The width formed by the plurality of second coil units 1211 connected in parallel is the width W21 of the second coil pattern unit 121, wherein the width of a single second coil unit 1211 is the same as the width of a single first coil unit 1111, and the width W11 of the first coil pattern unit 111 is greater than the width W21 of the second coil pattern unit 121 within the same coil pattern unit 1011. The final width W1 of the first coil pattern 11 is greater than the width W2 of the second coil pattern 12.

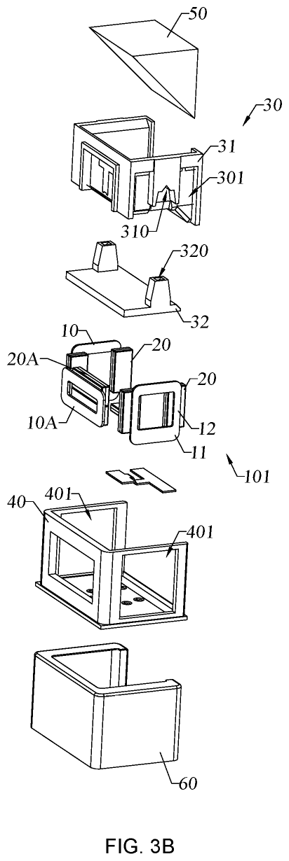

FIG. 3B is a simplified schematic view of one embodiment of the actuator of this application. The actuator comprises a coil assembly 10, a magnet 20, a movable member 30, a fixed member 40, and an optical module. One of the coil assembly 10 and the magnet 20 is mounted on the movable member 30, and the other is mounted on the fixed member 40. They interact to generate the driving force F which drives the movable member 30 to move with respect to the fixed member 40. The optical module is mounted on the movable member 30 and moves with the movable member 30. The optical module can be implemented as, but is not limited to, a lens module, a light path deflection module, a photosensitive chip, etc.

The coil assembly 10 is mounted on the movable member 30 and the magnet 20 is mounted on the fixed member 40, then the actuator is a moving coil type. If the coil assembly 10 is mounted on the fixed member 40 and the magnet is mounted on the movable member 30, then the actuator is a moving magnet type. This application does not limit this.

The movable member 30 is provided with a first assembly space 301 suitable for assembling one of the coil assembly 10 and the magnet 20. The fixed member 40 is provided with a second assembly space 401 suitable for assembling the other of the coil assembly 10 and the magnet 20. The first assembly space 301 and the second assembly space 401 are opposite to each other along the third direction. After assembling the coil assembly 10 and the magnet 20, a driving force in the first direction is generated. The second coil pattern 12 of the coil pattern 101 interacts with the magnet 20 to generate the driving force. The first coil pattern 11 does not participate in the interaction with the magnet 20, and its linewidth is larger than that of the second coil pattern 12, which can effectively reduce resistance and improve the quality of the actuator of this application.

The actuator of this application is applied to a camera module and can drive the movement of the optical module of the camera module. For example, the actuator drives the movement of the optical module to realize optical image stabilization (OIS), autofocus (AF), optical zoom, etc., wherein the optical module can be a lens module, a light path deflection module, and/or a photosensitive module. Specifically, the application of the actuator of this application in a camera module is illustrated using a periscope camera module as an example.

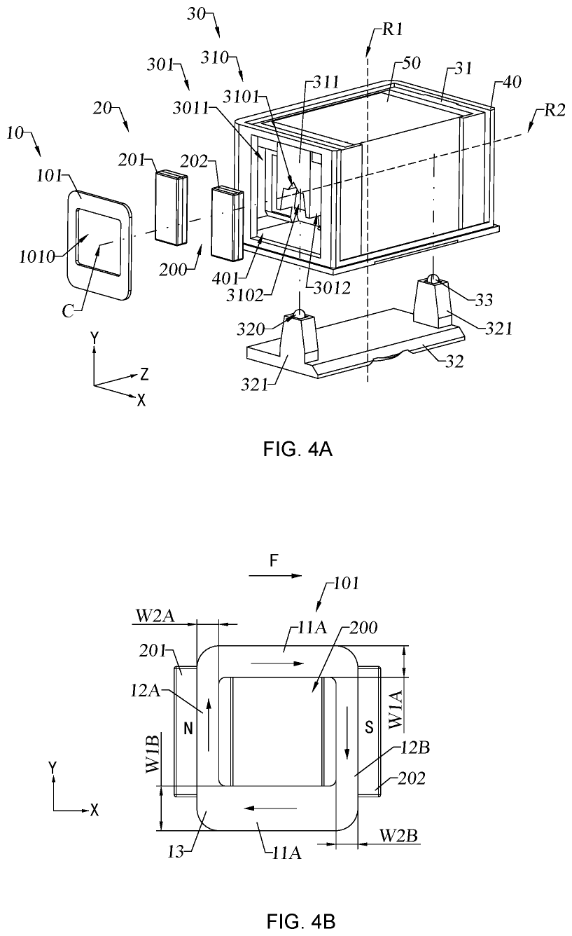

Referring to the schematic views in FIGS. 3A to 4B, the actuator of this application is used as a moving device for the light path deflection module of a periscope camera module. The actuator comprises a coil assembly 10, a magnet 20, a movable member 30, and a fixed member 40, exemplified by the coil assembly 10 being mounted on the fixed member 40 and the magnet 20 being mounted on the movable member 30. In other examples of this application, the embodiment in which the coil assembly 10 is mounted on the movable member 30 and the magnet 20 is mounted on the fixed member 40 is also feasible.

The actuator also comprises an actuated optical module which in this example is implemented as a light path deflection module 50. The light path deflection module 50 is mounted on the movable member 30. The coil assembly 10 and the magnet 20 interact to generate the driving force F, causing the movable member 30 to carry the light path deflection module 50 in motion.

The movable member 30 comprises a first movable component 31, a second movable component 32, and a guide component 33. The first movable component 31 and the second movable component 32 are movably mounted on the fixed member 40. The light path deflection module 50 is mounted on the first movable component 31, the second movable component 32 is mounted between the first movable component 31 and the fixed member 40, and the guide component 33 is mounted between the first movable component 31 and the second movable component 32 for guiding the movement of the first movable component 31. The first movable component 31, the guide component 33, and the second movable component 32 are assembled on the fixed member 40 along the second direction.

Light is incident on the light path deflection module 50 along the second direction (Y-axis), and after being deflected by the light path deflection module 50, it is emitted along the first direction (X-axis). The lens module and the photosensitive module (not shown in the drawings) are arranged sequentially on the emission side of the light path deflection module 50 along the first direction. The light passes through the lens module and reaches the photosensitive module, forming an image on the photosensitive area of the photosensitive module.

The actuator comprises a first actuator and a second actuator. The first actuator drives the light path deflection module 50 to rotate around a first rotation axis R1, and the second actuator drives the light path deflection module 50 to rotate around a second rotation axis R2. The first rotation axis R1 and the second rotation axis R2 are orthogonal. The first rotation axis R1 extends along the Y-axis direction, i.e., parallel to the light incident direction, and the second rotation axis R2 extends along the Z-axis direction, i.e., orthogonal to both the light incident and light emitting directions.

As shown in FIG. 3B, the second actuator comprises a second coil assembly 10A and a second magnet 20A. The second coil assembly 10A and the second magnet 20A are mounted with respect to each other on the movable member 30 and the fixed member 40 along the X-axis direction, and interact with each other to drive the light path deflection module 50 to rotate about the second rotation axis R2.

It is understood that the implementation of the second coil assembly 10A can refer to the implementation of the coil assembly 10, and can adopt a design with different linewidths, or a design with the same linewidth, or a conventional design.

The number of the guide components 33 can be two, and the two guide components are distributed opposite to each other along the Z-axis, located between the first movable component 31 and the second movable component 32. As shown in FIG. 4A, the second movable component 32 is assembled between the bottom of the first movable component 31 and the bottom of the fixed member 40 along the Y-axis, supporting the first movable component 31 along the Y-axis. The second movable component 32 comprises two support arms 321 distributed opposite to each other along the Z-axis and extending along the Y-axis. The two guide components 33 are respectively installed in the second receiving grooves 320 defined at the top of the two support arms 321. The bottom of the first movable component 31 is correspondingly provided with first receiving grooves 310 distributed opposite to each other along the Z-axis, each first receiving groove 310 is arranged for accommodating at least a portion of each of the corresponding guide component 33 and the corresponding support arm 321. The first receiving grooves 310 and the second receiving grooves 320 cooperate with each other to define the movement space of the guide components 33. When the second coil assembly 10A and the second magnet 20A of the second actuator interact, they drive the first movable component 31 to move. The guide component 33 guides the first movable component 31 to rotate around the second rotation axis R2, thereby realizing the nodding motion of the light path deflection module 50.

The first actuator comprises the aforementioned coil assembly 10 and magnet 20 which are distributed opposite to each other along the Z-axis on two sides of the movable member 30 and the fixed member 40. Specifically, the fixed member 40 has second assembly spaces 401 on both sides along the Z-axis, and the movable member 30 has first assembly spaces 301 on opposite sides along the Z-axis. At least two coil assemblies 10 are mounted opposite to each other on two sides of the fixed member 40 along the Z-axis, and at least two magnets 20 are mounted opposite to each other on two sides of the movable member 30 along the Z-axis.

The coil assembly 10 comprises coil patterns 101 and substrates 102. The substrates 102 are distributed on at least two opposite sides of the movable member 30 along the Z-axis direction to form the coil patterns 101 opposite to each other along the Z-axis direction.

Specifically, the coil assembly 10 and magnet 20 which are distributed on one side of the movable member 30 along the Z-axis are described. The implementation of the coil assembly 10 and magnet 20 distributed on the opposite side of the movable member 30 along the Z-axis is the same.

The coil pattern 101 comprises a first coil pattern 11 and a second coil pattern 12. The first coil pattern 11 is distributed along the first direction perpendicular to the light incident direction of the light path deflection module 50, and parallel to the light emitting direction of the light path deflection module 50. The second coil pattern 12 is distributed along the second direction parallel to the light incident direction of the light path deflection module 50 and perpendicular to the light emitting direction of the light path deflection module 50. The width W1 of the first coil pattern 11 is greater than the width W2 of the second coil pattern 12. The magnet 20 is arranged along a direction parallel to the plane determined by the light incident and light emitting directions of the light path deflection module 50, and the magnet 20 and the coil assembly 10 are opposite to each other along a direction perpendicular to the plane determined by the light incident and light emitting directions.

Referring to FIGS. 4A and 4B, the magnet 20 comprises a first portion 201 and a second portion 202. In this example, the first portion 201 and the second portion 202 are two independent magnets, with a gap 200 between them. The polarities of the portions of the first portion 201 and the second portion 202 facing the coil assembly 10 are different, such as forming an N-polarity portion and an S-polarity portion respectively. The polarities of the portions of the first portion 201 and the second portion 202 facing away from the coil assembly 10 are different, such as forming an S-polarity portion and an N-polarity portion respectively.

The magnetization directions of the first portion 201 and the second portion 202 are opposite and distributed along the third direction perpendicular to the extension distribution direction of the coil pattern 101, so as to be perpendicular to the current direction of the coil pattern 101.

The coil pattern 101 comprises second coil patterns 12A and 12B which are respectively opposite to the first portion 201 and the second portion 202, and each of the second coil patterns 12A and 12B faces one polarity portion. The coil pattern 101 also comprises first coil patterns 11A and 11B which face the first portion 201 and the second portion 202 respectively, and are respectively opposite to the two polarity portions of the magnet 20.

Each of the first portion 201 and the second portion 202 has a length extending along the Y-axis. Each of the second coil patterns 12A and 12B has a length extending along the Y-axis. Each of the first coil patterns 11A and 11B has a length extending along the X-axis. The extending directions of the first portion 201, the second portion 202, and the second coil patterns 12A and 12B are parallel to the light incident direction of the light path deflection module 50, and the extending directions of the first coil patterns 11A and 11B are parallel to the light emitting direction of the light path deflection module 50.

When an electric current is supplied in the coil pattern 101 in one direction, the electric current flows along the first coil pattern 11A, the second coil pattern 12B, the first coil pattern 11B and the second coil pattern 12A. The current directions in the second coil patterns 12A and 12B are opposite and are perpendicular to the magnetic field direction of the first portion 201 and the magnetic field direction of the second portion 202 respectively, and they interact to generate the driving force F.

The driving force F is parallel to the extension direction of the first coil patterns 11A and 11B and the current direction.

Currents in opposite directions are supplied to the coil assemblies 10 distributed on opposite sides of the movable member 30 along the Z-axis to generate driving forces in opposite directions, thereby driving the movable member 30 to rotate around the first rotation axis R1, so that the light path deflection module 50 rotates around the first rotation axis R1, realizing the swing motion of the light path deflection module 50.

A second guide component (not shown in the drawings) is provided between the second movable component 32 and the fixed member 40. The second guide component guides the second movable component 32 to rotate around the first rotation axis R1, so that the first movable component 31 carries the light path deflection module 50 to rotate around the first rotation axis R1.

The fixed member 40 is mounted on the base 60 which can serve as a housing and/or a base.

Referring to the schematic view of FIG. 4A, there is a gap 200 between the first portion 201 and the second portion 202. The first assembly space 301 of the movable member 30, which is configured to assemble the magent 20, is divided into a first movable assembly space 3011 and a second movable assembly space 3012 that are spaced apart from each other. The first movable assembly space 3011 and the second movable assembly space 3012 are distributed at intervals along the X-axis and are formed on opposite sides of the first movable component 31 along the Z-axis.

The portion between the first movable assembly space 3011 and the second movable assembly space 3012 is defined as a receiving portion 311, that is, the gap 200 between the first portion 201 and the second portion 202 is filled by the receiving portion 311. The receiving portion 311 protrudes outward relative to the inner wall defining the first movable assembly space 3011 and the second movable assembly space 3012, and the receiving portion 311 has a first receiving groove 310 extending upward from the bottom of the receiving portion 311 along the Y-axis direction. Further, a second sub-receiving groove 3102 and a first sub-receiving groove 3101 extend upward along the Y-axis direction.

The second movable component 32 is assembled to the bottom of the first movable component 31 along the Y-axis. The support arm 321 is located in the second sub-receiving groove 3102. The second receiving groove 320 defined by the top of the support arm 321 and the first sub-receiving groove 3101 cooperate to define the receiving space of the guide component 33. The guide component 33 guides the first movable component 31 to move.

Therefore, the guide component 33 is disposed between the first portion 201 and the second portion 202 of the magnet 20, forming the fulcrum of motion of the first movable component 31. Furthermore, at least two guide components 33 are disposed opposite to each other along the Z-axis and respectively located between the first portion 201 and the second portion 202 of the magnets 20 distributed on two sides of the movable member 30. The center point of the guide component 33 is located on the second rotation axis R2. The line connecting the center points of the at least two guide components 33 coincides with the second rotation axis R2, and the extending direction of the second rotation axis R2 passes through the gap 200 between the first portion 201 and the second portion 202.

Furthermore, in some examples, the extension direction of the second rotation axis R2 passes through the center point C of the spacing space 1010 of the coil pattern 101, so that the light path deflection module 50 is subjected to uniform force and the movement is more stable and precise.

First coil patterns 11A and 11B are extended along the first direction perpendicular to the light incident direction. The gap 200 is located between the first portion 201 and the second portion 202 along this first direction. The first coil patterns 11A and 11B are opposite to the first portion 201, the gap 200, and the second portion 202 along the third direction. The widths W1A and W1B of the first coil patterns 11A and 11B are greater than the widths W2A and W2B of the second coil patterns 12A and 12B, so as to effectively reduce the resistance of the coil pattern 101.

Furthermore, the widths W2A and W2B of the second coil patterns 12A and 12B are the same. The widths W1A and W1B of the first coil patterns 11A and 11B can be implemented as the same or as different, as long as either one is greater than W2A and W2B.

In other examples of this application, the first portion 201 and the second portion 202 of the magnet 20 are distributed with small intervals or no intervals to reduce the space occupied by the magnet 20. Correspondingly, the interval between the second coil patterns 12A and 12B is small to reduce the volume of the coil assembly 10.

The foregoing examples illustrate that the coil assembly 10 with a widened design of this application is implemented as an OIS coil assembly for the swinging motion of the light path deflection module 50. In other examples of this application, the coil assembly 10 with a widened design is implemented as an OIS coil assembly at the bottom or rear of the light path deflection module 50.

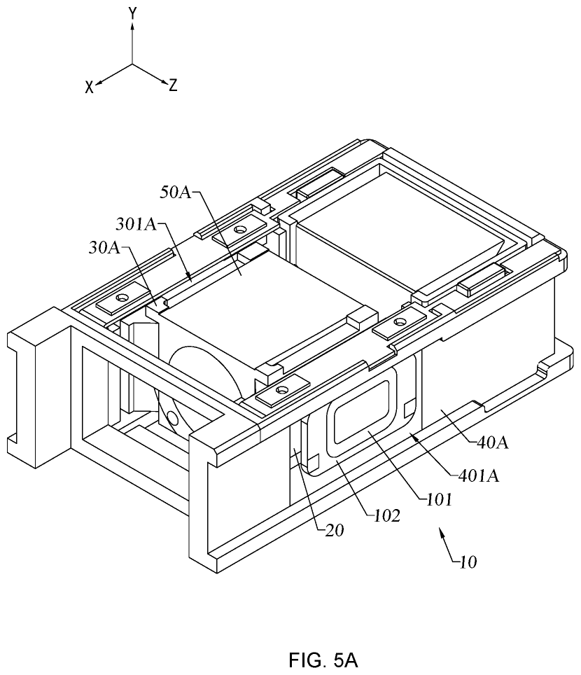

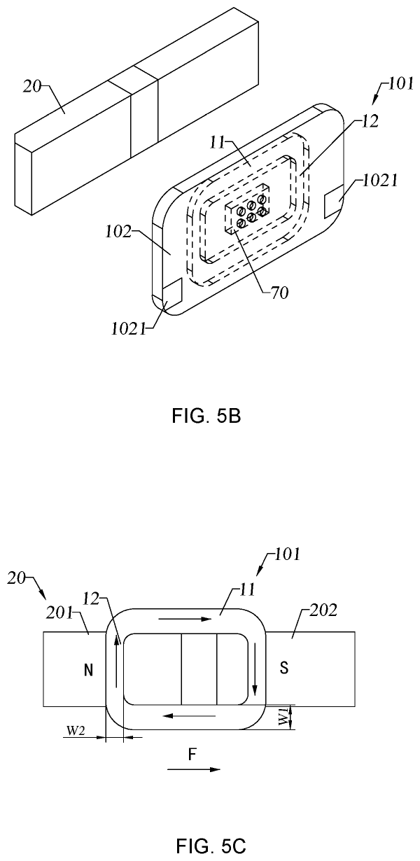

Referring to FIGS. 5A to 5C, an example is shown of the coil assembly 10 and magnet 20 of this application being applied to the lens module actuator of a periscope camera module. In this example, the movable member 30A is implemented as a lens carrier, the optical module is implemented as a lens module 50A, and the movable member 30A carries the lens module 50A to move along its optical axis. The fixed member 40A is implemented as the base of the periscope camera module. Light emitted from the light path deflection module along the first direction (X-axis) reaches the photosensitive module through the lens module 50A. At least one of the two sides of the movable member 30A opposite to each other along the third direction (Z-axis) is provided with a first assembly space 301A, and at least one of the two sides of the fixed member 40A opposite to each other along the third direction is provided with a second assembly space 401A, the second assembly space 401A and the first assembly space 301A are opposite to each other along the third direction. One of the coil assembly 10 and the magnet 20 is assembled in the first assembly space 301A and the other is assembled in the second assembly space 401A, so as to interact and drive the lens carrier to carry the lens module 50A to move along the first direction, adjust the focus, and realize the AF function or optical zoom, etc.

The coil assembly 10 and the magnet 20 can be assembled on opposite sides of the movable member 30A and the fixed member 40A, or the coil assembly 10 and the magnet 20 can be assembled on one side.

The first coil pattern 11 of the coil pattern 101 extends along the first direction (X-axis) which is parallel to the optical axis direction of the lens module 50A, and the second coil pattern 12 extends along the second direction (Y-axis) which is perpendicular to the optical axis direction of the lens module 50A. The second coil pattern 12 and the magnet 20 are opposite to each other along another direction perpendicular to the optical axis of the lens module 50A, or in other words, perpendicular to the coil pattern 101 (third direction, Z-axis), and interact to generate a force along the optical axis direction of the lens module 50A, so as to drive the movable member 30 to carry the lens module 50A to move along the optical axis of the lens module 50A.

The width W1 of the first coil pattern 11 is greater than the width W2 of the second coil pattern 12, so as to reduce the resistance at the first coil pattern 11, thereby reducing the resistance of the coil assembly 10, improving its quality, and reducing losses.

The foregoing examples illustrate the application of the actuator to a periscope camera module. In other examples of this application, the actuator can be applied to a vertical camera module. The optical module can be implemented as an optical lens or a photosensitive chip of the vertical camera module. The coil assembly 10 and the magnet 20 interact to drive the optical lens to move in a plane perpendicular to its optical axis to achieve lens-motion OIS, or to drive the photosensitive chip to move in a plane perpendicular to its optical axis to achieve chip-motion OIS.

The actuator coil assembly 10 provided in this application features a widened design. This widening does not affect the overall length or number of turns of the coil assembly 10. Instead, it widens only a portion of the coil pattern 101. Based on the original design, this increases the cross-sectional area of a portion of the coil pattern 101, so as to reduce resistance while avoiding excessive increase in the volume of the coil assembly 10. The implementation method and degree of widening can be determined according to design requirements. Furthermore, the width of the first coil pattern unit 111 in each circle of the coil pattern 101 can be increased or a parallel circuit design can be used to reduce the resistance of each coil pattern unit, thereby improving the quality of the coil assembly 10.

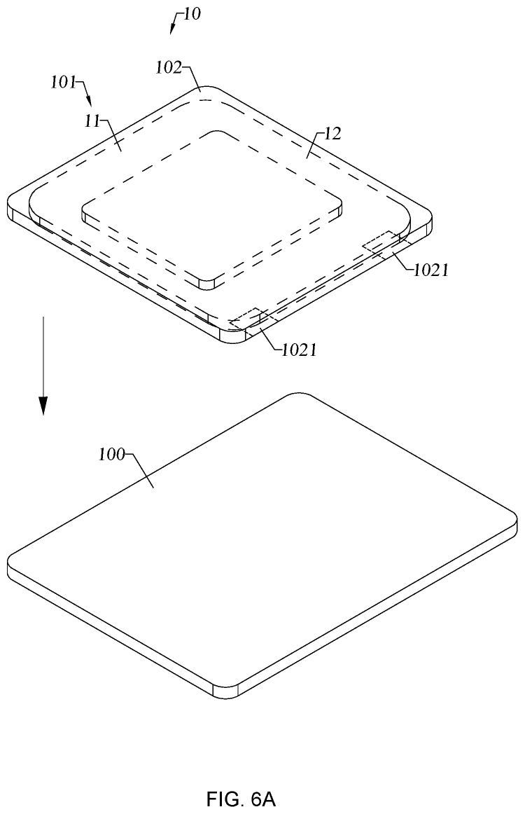

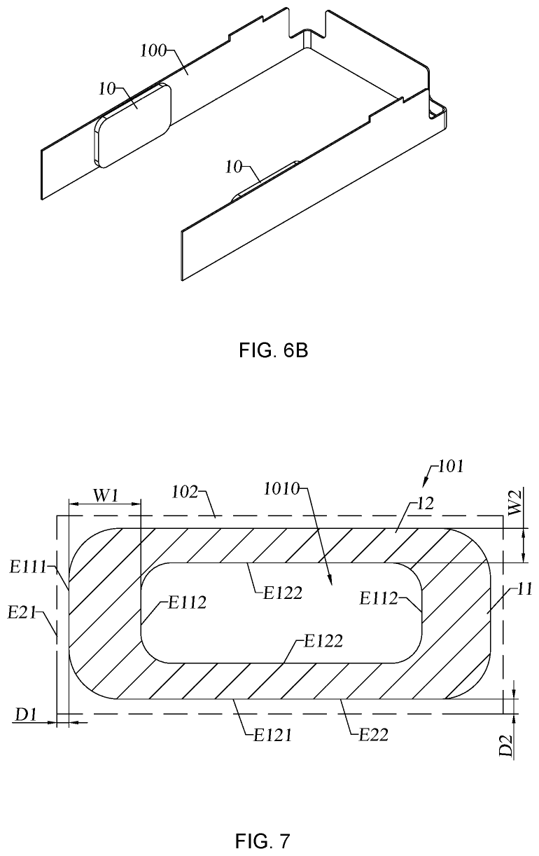

Referring to the schematic views in FIGS. 6A and 6B, the coil assembly 10 of this application is mounted to the printed circuit board 100. More preferably, the substrate 102 is provided with a soldering area 1021 which is located at the edge of the substrate 102, or near the edge of the substrate 102. The soldering area 1021 is soldered to the printed circuit board 100 for achieving a fixed connection and a conductive connection between the coil assembly 10 and the printed circuit board 100. Further, the coil pattern 101 leads out positive and negative terminals and is electrically conductively connected to the printed circuit board 100 for allowing the coil pattern 101 to obtain the electric current through the printed circuit board 100.

In one embodiment, the printed circuit board 100 is implemented as a flexible printed circuit board. In other embodiments, it may also be implemented as a rigid board, a rigid-flex board, etc.

Referring to the examples in FIGS. 3A to 4B, the printed circuit board 100 shown in FIG. 6A can be mounted to a periscope camera module to be used as the mainboard of the periscope camera module, or as a stabilization circuit board. The printed circuit board 100 is mounted on the fixed member 40 around the movable member 30. Coil assemblies 10 are mounted on the two surfaces of the printed circuit board 100 facing the movable member 30 in the third direction, so that the coil assemblies 10 are distributed on two sides of the movable member 30. A second coil assembly 10A is mounted on the surface facing the movable member 30 in the first direction, so that the second coil assembly 10A is distributed on one side of the movable member 30.

Referring to the examples in FIGS. 5A to 5C, the printed circuit board 100 shown in FIGS. 6A and 6B can be mounted to a periscope camera module for serving as the mainboard of the periscope camera module or a focus adjustment circuit board. Coil assemblies 10 are mounted on the surface of the printed circuit board 100 facing the lens module 50A or on opposite sides.

Referring to the examples in FIGS. 3A to 5C and to FIG. 6B, the printed circuit board 100 may extend integrally from the outside of the light path deflection module 50 to t he outside of the lens module 50A. In other words, the periscope camera module comprises an integrally extended printed circuit board 100 with the coil assembly 10 mounted on the surface facing the light path deflection module 50 and the lens module 50A.

Furthermore, referring to the schematic view of FIG. 7, the distances from the outermost edges of the coil pattern 101 to the corresponding edges of the substrate 102 are equal. Specifically, the outermost edge of the first coil pattern 11 is edge E111, the edge of substrate 102 extending along the first direction is edge E21, and the distance between edge E111 and edge E21 is D1. The outermost edge of the second coil pattern 12 is edge E121, the edge of substrate 102 extending along the second direction is E22, and the distance between edge E121 and edge E22 is D2, wherein D1 is equal to D2. That is, the distance from the edge of the first coil pattern 11 to the edge of substrate 102 is the same as the distance from the edge of the second coil pattern 12 to the edge of substrate 102.

The coil pattern 101 has an inner spacing space 1010. The distance between the innermost edges E112 of the first coil patterns 11 on two sides defines the distance of the inner spacing space 1010 along the second direction. The distance between the innermost edges E122 of the second coil patterns 12 on two sides defines the distance of the inner spacing space 1010 along the first direction.

When widening the first coil pattern 11, it is widened in the direction opposite to the innermost edge E112, that is, the first coil pattern 11 is widened outward, so as to avoid affecting the size of the inner spacing space 1010.

In some examples, the actuator of this application also comprises a position sensor 70 for detecting position changes, so that the actuator can make corresponding adjustment movements to achieve image stabilization, focusing, zooming, etc. Referring to FIG. 5B, the position sensor 70 is disposed in the inner spacing space 1010 to avoid occupying additional space and improve space utilization.

According to another aspect of this application, and in conjunction with the examples in FIGS. 1A to 7, this application also provides a method for manufacturing a camera module, comprising the following steps.

A coil pattern 101 is formed on a substrate 102. The coil pattern 101 comprises a first coil pattern 11 extending along a first direction and a second coil pattern 12 extending along a second direction perpendicular to the first direction. The width of the first coil pattern 11 is greater than the width of the second coil pattern 12.

A coil assembly 10 formed by the coil pattern 101 and the substrate 102 is soldered to the printed circuit board 100.

One of the coil assembly 10 and the magnet 20 is installed to the movable member 30, and the other is installed to the fixed member 40.

The magnet 20 comprises a first portion 201 and a second portion 202. The first portion 201 and the second portion 202 form polarity portions with different polarities on the side facing the coil assembly, and the first portion 201 and the second portion 202 are arranged along the first direction.

The above description is merely a preferred embodiment of this application and an explanation of the technical principles employed. Those skilled in the art should understand that the scope of the invention involved in this application is not limited to technical solutions formed by specific combinations of the above-described technical features, but should also cover other technical solutions formed by arbitrary combinations of the above-described technical features or their equivalents without departing from the inventive concept. For example, technical solutions formed by substituting the above features with (but not limited to) technical features with similar functions disclosed in this application.

What is claimed is:

1. A camera module, comprising:
an optical module, a movable member, a coil assembly, and a magnet, wherein the optical module is mounted on the movable member, one of the coil assembly and the magnet is mounted on the movable member, wherein the coil assembly and the magnet are arranged to interact to generate a driving force that drives the movable member to carry the optical module to move;
wherein the magnet comprises a first portion and a second portion, wherein the first portion and the second portion respectively form poles with different polarities on a side facing the coil assembly;
wherein the coil assembly comprises a coil pattern, wherein the coil pattern comprises a first coil pattern extending along a first direction and a second coil pattern extending along a second direction perpendicular to the first direction;
wherein an extending direction of the first coil pattern is parallel to an arrangement direction of the first portion and the second portion, and a width of the first coil pattern is greater than a width of the second coil pattern.

2. The camera module according to claim 1, wherein the first coil pattern is protruded at least partially with respect to the magnet along the second direction.

3. The camera module according to claim 2, wherein the first coil pattern is oriented toward the first portion and the second portion.

4. The camera module according to claim 1, wherein the coil pattern comprises a plurality of coil pattern units each comprising a first coil pattern unit extending along the first direction and a second coil pattern unit extending along the second direction, wherein a width of the first coil pattern unit is greater than a width of the second coil pattern unit.

5. The camera module according to claim 4, wherein the first coil pattern unit comprises a plurality of coil units connected in parallel.

6. The camera module according to claim 4, wherein a distance between each two coil pattern units is the same, and a distance between each two adjacent first coil pattern units is the same, and a distance between each two adjacent second coil pattern units is the same.

7. The camera module according to claim 1, wherein the first coil pattern and the second coil pattern are at the same distance from corresponding edges of the substrate.

8. The camera module according to claim 1, further comprising a printed circuit board, wherein the coil assembly is soldered on the printed circuit board, wherein the coil assembly comprises a substrate and the coil pattern formed on the substrate, wherein the substrate is provided with at least one soldering area for fixed connection with the printed circuit board.

9. The camera module according to claim 8, further comprising a fixed member, wherein the movable member is movably mounted to the fixed member, and the other of the coil assembly and the magnet is mounted to the fixed member.

10. The camera module according to claim 9, wherein the optical module is a light path deflection module, wherein the coil assembly and the magnet are mounted on two sides of the light path deflection module, the extending direction of the first coil pattern is parallel to a light emitting direction of the light path deflection module, and an extending direction of the second coil pattern is parallel to a light incident direction of the light path deflection module, wherein the magnet and the coil assembly are arranged to interact to generate the driving force parallel to the light emitting direction to drive the light path deflection module to rotate around a first rotation axis which is parallel to the light incident direction.

11. The camera module according to claim 10, wherein the movable member comprises a first movable component, a second movable component, and a guide component, wherein the first movable component and the second movable component are movably mounted on the fixed member along the second direction, the guide component is mounted between the first movable component and the second movable component to guide a movement of the first movable component, wherein the camera module further comprises a second coil assembly and a second magnet, the second coil assembly and the second magnet are respectively mounted on the fixed member and the first movable component along the first direction to drive the first movable component to rotate around a second rotation axis.

12. The camera module according to claim 11, wherein the second movable component is mounted on a bottom of the first movable component along the second direction, wherein the second movable component comprises two support arms extending along the second direction and opposite to each other along the third direction, wherein the two support arms are extended to two opposite sides of the first movable component along the third direction, wherein each of the two support arms has a second receiving groove at a top thereof, wherein each said guide component is fitted into the corresponding second receiving groove, wherein a center position of the guide component is located at the second rotation axis.

13. The camera module according to claim 12, wherein a gap is defined between the first portion and the second portion, each of the two support arms is located in the gap, and portions of the first portion and the second portion facing the coil assembly form poles with opposite polarities.

14. The camera module according to claim 13, wherein a side of the first movable component is provided with a first movable assembly space and a second movable assembly space, the first portion and the second portion are respectively assembled in the first movable assembly space and the second movable assembly space, a receiving portion is provided between the first movable assembly space and the second movable assembly space, and the receiving portion is provided with a first sub-receiving groove and a second sub-receiving groove along the second direction, at least a part of the guide component is received into the first sub-receiving groove, and one of the two support arms is extended into the second sub-receiving groove.

15. The camera module according to claim 9, wherein the optical module is a lens module, and the coil assembly and the magnet are disposed on at least one side of the lens module and arranged to interact to generate the driving force parallel to an optical axis of the lens module, wherein the extension direction of the first coil pattern is parallel to the optical axis of the lens module.

16. The camera module according to claim 1, wherein a projection of the second coil pattern along a third direction falls within a projection of the magnet along the third direction, wherein the third direction is perpendicular to both the first direction and the second direction, wherein a distance that the second coil pattern extends along the second direction does not exceed a distance that the magnet extends along the second direction.

17. The camera module according to claim 5, wherein the second coil pattern unit comprises a plurality of second coil units, a number of the plurality of second coil units is less than a number of the plurality of coil units of the first coil pattern unit.

18. The camera module according to claim 11, wherein the guide component is disposed between the first portion and the second portion of the magnet to form a fulcrum of motion of the first movable component.

19. The camera module according to claim 18, wherein at least two said guide components are disposed opposite to each other along a third direction which is perpendicular to both the first direction and the second direction.

20. The camera module according to claim 18, wherein a gap is defined between the first portion and the second portion, wherein a center point of each said guide component is located on the second rotation axis, a line connecting the center points of the at least two said guide components coincides with the second rotation axis, and an extending direction of the second rotation axis passes through the gap between the first portion and the second portion.
